(19) United States
(12) Patent Application Publication
(10) Pub. No.: US 2008/0114893 A1
(43) Pub. Date: May 15, 2008

(54) METHOD AND APPARATUS FOR GUARANTEEING SERVICE SPECIFIC BANDWIDTH IN THE ETHERNET FRAME TRANSMISSION SYSTEM

(76) Inventors: Ji Wook YOUN, Daejeon (KR); Bheom Soon JOO, Daejeon (KR); Jung Sik KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/923,944

(22) Filed: Oct. 25, 2007

(30) Foreign Application Priority Data
Nov. 15, 2006 (KR) 10-2006-00112891

(51) Int. Cl. G06F 15/16

(52) U.S. Cl. 709/235

(57) ABSTRACT

An apparatus and method for guaranteeing a service specific bandwidth in an Ethernet frame transmission system. In the method, memory status information of an input frame buffer and usable bandwidth information of a present Ethernet network are obtained if congestions or errors occur in the Ethernet frame transmission system. Then, different pause times by service specific priorities are set based on the memory status information and the usable bandwidth information. A MAC control frame including the pause frame is provided to the corresponding adjacent nodes. A media access control processor, if the received Ethernet frame is the MAC control frame, detects the pause times by priorities in the detected pause frame. A single processor generates drop information by priorities. A network processor drops a corresponding Ethernet frame according to the drop information by priorities, which is generated from the signal processor.

### CLAIM OF PRIORITY

This application claims the benefit of Korean Patent Application No. 2006-112891 filed on Nov. 15, 2006 in the Korean Intellectual Property Office, the disclosure of which is incorporated herein by reference.

### BACKGROUND OF THE INVENTION

1. Field of the Invention

The present invention relates to an Ethernet frame transmission in an Ethernet network, and more particularly, to an apparatus and method for guaranteeing performance according to each Ethernet frame and a service specific bandwidth in an Ethernet frame transmission system.

This work was supported by the IT R&D program of MIC/IITA [2005-S-101-02, Multimedia QoS Routing Technology Development]

2. Description of the Related Art

A transmission system at a receiver side in an Ethernet network, when provided with data (hereinafter called a frame) cannot process the frame immediately. Thus, the transmission system executes flow control, storing the frame in a buffer until the frame can be processed. Specifically, an operation system or a switch for processing the received frame may have delay in the processing and thus the buffer of the receiver may be filled with the frame. Notwithstanding if the frame is transmitted continuously from a transmitter side, system errors or congestions may occur, bringing about waste in a bandwidth and loss in the frame. Accordingly, in the flow control of the transmission system, the receiver having the buffer filled with the frame requests the transmitter to pause transmission temporarily.

In a case where system errors or congestions occur, an Ethernet frame transmission system of a conventional Ethernet network guarantees transmission performance by inserting a pause frame signal into an Ethernet Media Access Control (MAC) header and thereby controlling transmission/reception of the Ethernet frame. In this conventional method, when a pause frame is inputted from an adjacent node, transmission of the Ethernet frame for a corresponding port is paused for a predetermined time. That is, regardless of type of service or priorities, the Ethernet frame transmission is paused for a pause timer value designated in the pause frame, and all frames are arbitrarily dropped. Therefore, in this conventional method, a longer pause timer value causes the Ethernet frame to be dropped arbitrarily from the port inputted with the pause frame.

Therefore, the conventional pause frame, when used to control transmission/reception of the Ethernet frame does not guarantee a bandwidth according to a specific service. Also, congestions generated in a node affect an adjacent node in terms of an entire Ethernet frame transmission network, thereby presenting a difficulty in managing an entire network effectively.

### SUMMARY OF THE INVENTION

The present invention has been made to solve the foregoing problems of the prior art and therefore an aspect of the present invention is to provide an apparatus and method for guaranteeing performance according to each Ethernet frame and a service specific bandwidth in an Ethernet frame transmission system of an Ethernet network.

Another aspect of the invention is to provide an apparatus and method for setting different pause times by service specific priorities, guaranteeing performance by an Ethernet frame unit and a service specific bandwidth in a case where a pause frame is generated due to congestions and errors in an Ethernet frame transmission system.

According to an aspect of the invention, the invention provides a method for guaranteeing a service specific bandwidth in an Ethernet frame transmission system, the method including monitoring congestions or errors in the Ethernet frame transmission system; obtaining memory status information of an input frame buffer and usable bandwidth information of a present Ethernet network if congestions or errors occur in the Ethernet frame transmission system; setting different pause times by service specific priorities based on the memory status information and the usable bandwidth information; generating a pause frame having the set pause times; and transmitting a MAC (media access control) control frame including the pause frame to the corresponding adjacent nodes.

According to another aspect of the invention, the invention provides a method for guaranteeing a service specific bandwidth in an Ethernet frame transmission system, the method including monitoring an Ethernet frame inputted through a corresponding port from each of adjacent nodes; deciphering a MAC control frame inputted if the Ethernet frame is a MAC control frame; detecting a pause frame from the deciphered MAC control frame; detecting pause times set differently by priorities assigned per service class from the detected pause frame; generating drop information by priorities based on the detected pause times; and dropping a corresponding Ethernet frame based on the generated drop information.

According to further another aspect of the invention, the invention provides an apparatus for guaranteeing a service specific bandwidth in an Ethernet frame transmission system, the apparatus including a frame transceiver for transmitting/receiving Ethernet frames through a plurality of ports; a media access control processor for monitoring the ports, identifying usable bandwidth information of a present Ethernet network depending on congestions or system errors, and deciphering the received Ethernet frames; an input Ethernet frame buffer for storing the received Ethernet frames temporarily; a signal processor for setting different pause times by service specific priorities based on memory state information of an input Ethernet frame buffer and the usable bandwidth information, adding a pause frame including the set pause times to a MAC control frame and providing the MAC control frame to adjacent nodes; a network processor for classifying the Ethernet frames, inputted from the input Ethernet frame buffer, by services, assigning the Ethernet frames with priorities, and outputting the priority-assigned Ethernet frames; and an output Ethernet frame buffer for storing the output Ethernet frames temporarily.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration view illustrating a bandwidth guarantee apparatus for transmitting an Ethernet frame in an Ethernet frame transmission system according to an exemplary embodiment of the invention;

FIG. 2 is configuration view illustrating an MAC control frame standard and an MAC control parameter according to an exemplary embodiment of the invention;

FIG. 3 is a table illustrating the association relationship between Ethernet VLAN priority bits and priority values in an MAC control parameters according to an exemplary embodiment of the invention;

FIG. 4 is a flow chart illustrating generation of an MAC control frame having pause times by priorities in an Ethernet frame transmission system according to an exemplary embodiment of the invention; and

FIG. 5 is a flow chart illustrating a signal flow for guaranteeing service specific performance in a case where a pause frame is inputted in an Ethernet frame transmission system according to an exemplary embodiment of the invention.

### DETAILED DESCRIPTION OF THE PREFERRED EMBODIMENT

Exemplary embodiments of the present invention will now be described in detail with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference signs are used to designate the same or similar components throughout.

The exemplary embodiments of this invention adopt a transmission system for transmitting Ethernet frames of an Ethernet network. A detailed description will be given of a bandwidth guarantee apparatus which guarantees performance by an Ethernet frame unit and a service specific bandwidth in a case where a pause frame is generated in an Ethernet frame transmission system with reference to the accompanying drawings.

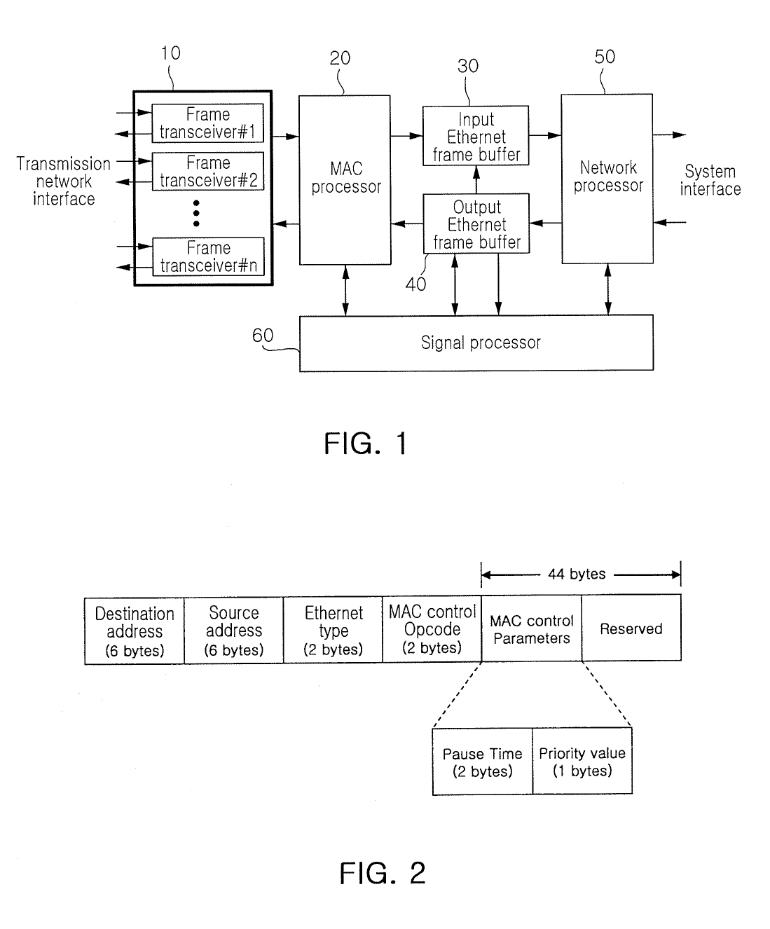

FIG. 1 is a configuration view illustrating a bandwidth guarantee apparatus for transmitting an Ethernet frame in an Ethernet frame transmission system according to an exemplary embodiment of the invention.

Referring to FIG. 1, the bandwidth guarantee apparatus in the Ethernet frame transmission system includes a frame transceiver 10, a media access control (MAC) processor 20, an input Ethernet frame buffer 30, an output Ethernet frame buffer 40, a network processor 50 and a signal processor 60.

The frame transceiver 10 includes a plurality of frame transceivers #1, #2, . . . #n and transmits/receives Ethernet frames through a plurality of ports.

The MAC processor 20 deciphers header information of the Ethernet frames received from the Ethernet transceiver 10, detects a pause frame from the deciphered header information and transmits status information of a corresponding port and information of an MAC control frame to a signal processor 60. The MAC processor 20 receives the Ethernet frame from the Ethernet transceiver 10 and checks whether the pause frame is present in an MAC header of the received Ethernet frame. If the pause frame is not present, the MAC processor 20 transmits the Ethernet frame to the input Ethernet frame buffer 30.

The input Ethernet frame buffer 30 stores the Ethernet frame processed by the MAC processor 20 temporarily, transmits the Ethernet frame to the network processor 50 and transfers memory state information to a signal processor 60. Here, the input Ethernet frame buffer 30 has different critical values by priorities.

The output Ethernet frame buffer 40 stores the Ethernet frame outputted from the network processor 50 temporarily and transfers the memory state information to the signal processor 60. Also, the output Ethernet frame buffer 40 has different critical values by priorities.

The network processor 50 classifies the Ethernet frames by services or destinations according to the rule set by the signal processor 60 and processes the Ethernet frames. Moreover, the network processor 50 assigns priority labels for frame dropping in a case where congestions occur in the system or a pause frame signal is inputted from an adjacent node, and drops a corresponding one of the Ethernet frames based on drop information inputted from the signal processor 60.

The signal processor 60 processes an MAC control frame inputted from the MAC processor 20 and sets different pause times by services. Here, the signal processor 60, if the pause frame is inputted, deciphers an MAC control parameter field in the MAC control frame and detects the pause times by priorities. The signal processor 60 generates the drop information based on the pause times by priorities, state information of the output Ethernet frame buffer 40 and usable bandwidth information of a network and then transmits the drop information to the network processor 50. Furthermore, the signal processor 60 sets critical values for the input Ethernet frame buffer 30 and the output Ethernet frame buffer 40, respectively, and stores and manages a result processed by the network processor 50.

Now, a detailed description will be given of a method for guaranteeing a service specific bandwidth according to Ethernet frames in a bandwidth guarantee apparatus in an Ethernet frame transmission system configured as above. First, FIG. 2 illustrates an MAC control frame standard and an MAC control parameter type.

Referring to FIG. 2, the MAC control frame standard (IEEE 802.3) includes a 6-byte destination address, a 6-byte source address, a 2-byte Ethernet type, a 2-byte MAC control operation (Op) code, and the remaining 44 byte field of MAC control parameters and a reserved field. Here, the MAC control parameters include a 2-byte pause time and a 1-byte priority value field.

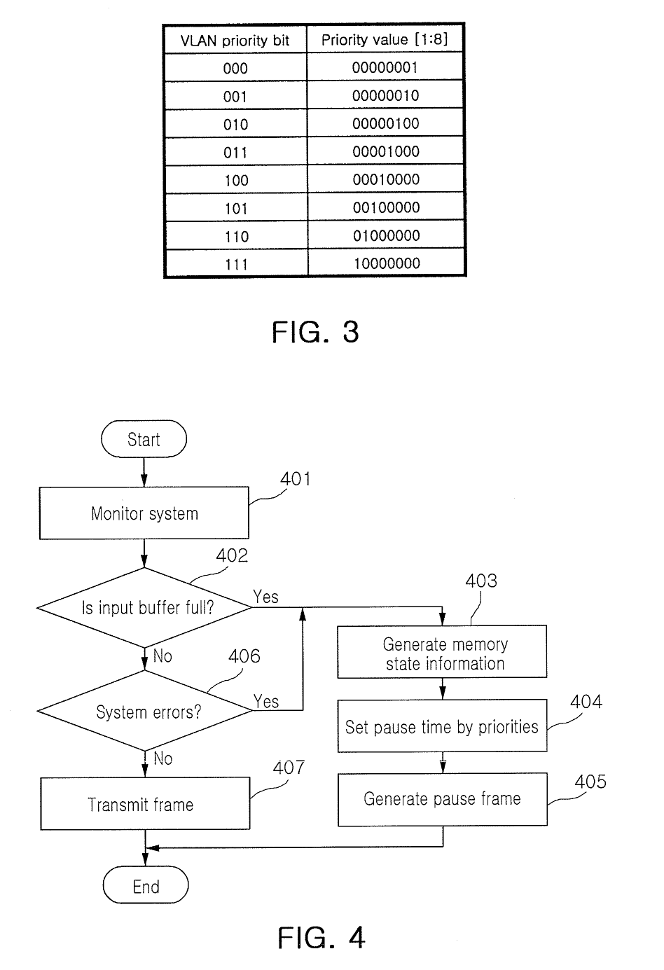

The MAC control Op code has 0x0001, a value indicative of a pause frame, inserted thereinto if the Ethernet transmission network has errors or congestions that may prevent normal reception of the Ethernet frame. Here, the priority value field also has priority values inserted thereinto. These priority values are associated with Ethernet VLAN priority bits. FIG. 3 illustrates an example of such association.

For example, if a VLAN priority bit is ‘000’, a priority value [1:8] is set to ‘00000001.’ When the VLAN priority bits and the priority values are matched one by one, the priority bits can be mapped into the MAC control parameter differently according to purpose, and the type of the Ethernet frames used in the Ethernet network.

Now, a description will be given of a method for generating an MAC control frame having different pause times by priorities and guaranteeing a service specific bandwidth in an Ethernet frame transmission system according to an exemplary embodiment of the invention.

FIG. 4 is a flow chart illustrating a generation of an MAC control frame having different pause times by priorities in the Ethernet frame transmission system according to an exemplary embodiment of the invention.

Referring to FIG. 4, the bandwidth guarantee apparatus monitors abnormalities such as congestions in an Ethernet network or system errors, through an MCA processor 20, to generate a pause frame in operation 401. Here, the bandwidth guarantee apparatus monitors an input frame buffer state and checks whether the input frame buffer 30 is full in operation 402. If the input frame buffer 30 is full, the bandwidth guarantee apparatus transmits memory state information to a signal processor 60 in operation 403.

Accordingly, the bandwidth guarantee apparatus sets pause times by priorities, i.e., by services based on the memory state information inputted from the input frame buffer 30 and usable bandwidth information of the present Ethernet network in operation 404, through a signal processor 60. Then, the bandwidth guarantee apparatus transmits the pause frames having time information to adjacent nodes and the operation of the bandwidth guarantee apparatus is finished in operation 405.

Meanwhile if the input frame buffer 30 is not full, i.e., in a normal state in operation 406, the bandwidth guarantee apparatus monitors system errors in the MAC processor 20 or the network processor 50. If there are any system errors, operation 403 is resumed, and if there are no system errors, a normal frame is transmitted in operation 407 and the operation of bandwidth guarantee apparatus is finished.

Then, a description will be given of a method for guaranteeing a service specific bandwidth in a case where pause frames are inputted from adjacent nodes through an MAC control frame in a bandwidth guarantee apparatus.

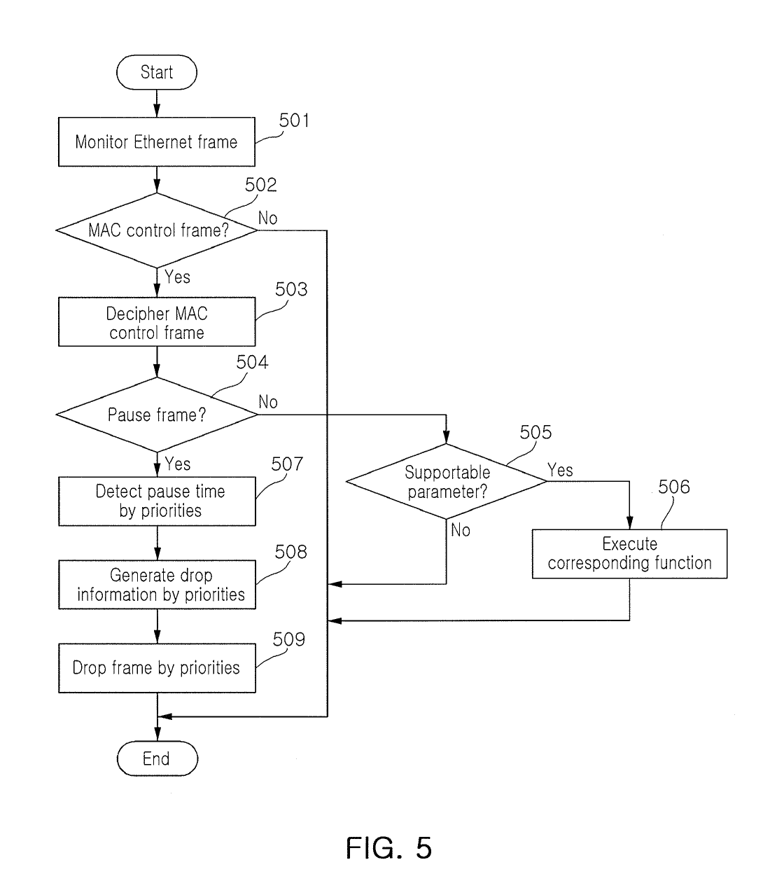

FIG. 5 is a flow chart illustrating signal flow for guaranteeing service specific performance in a case where the pause frame is inputted in the Ethernet frame transmission system according to an exemplary embodiment of the invention.

Referring to FIG. 5, the bandwidth guarantee apparatus monitors an Ethernet frame inputted to each port of the frame transceiver 10, through the MAC processor 20, in operation 501 and checks whether an MAC control frame is inputted in operation 502. If the MAC control frame is not inputted, the operation of the bandwidth guarantee apparatus is finished. On the other hand, if the MAC control frame is inputted, the bandwidth guarantee apparatus deciphers the MAC control frame inputted through a signal processor 60, in operation 503. The bandwidth guarantee apparatus checks whether an MAC control parameter value is a pause frame, through the deciphered MAC control frame, in operation 504. If the MAC control parameter value is not the pause frame, operation 505 is executed. If the MAC control parameter value is the pause frame, operation 507 is executed.

The bandwidth guarantee apparatus judges a supportable parameter value in operation 505. In case of the supportable parameter value, operation 506 is executed. In case of not the supportable parameter value, related information is forwarded to an upper layer system manager and the operation of the bandwidth guarantee apparatus is finished.

In the meantime, the bandwidth guarantee apparatus, if the pause frame is inputted, detects pause times and priority information from the pause frame in operation 507. Here, the signal processor 60 generates drop information based on the detected pause times by priorities, state information about an output Ethernet frame buffer 40 and usable bandwidth information of a network. Then, the bandwidth guarantee apparatus provides drop information by priorities, which is generated in the signal processor 60, to the network processor 50 in operation 508. The bandwidth guarantee apparatus drops a corresponding Ethernet frame (packet) based on the drop information, through the network processor 50 in operation 509 and the operation of bandwidth guarantee apparatus is finished.

As described above, according to the present embodiment, a separate priority field in addition to the pause times is assigned to the MAC control frame to set different pause times by priorities. Therefore, an Ethernet frame with a lower priority has a greater pause time than an Ethernet frame with a higher priority. This enables the Ethernet frame with a lower priority to be dropped selectively, thereby ensuring differential service performance by Ethernet frames.

As set forth above, according to exemplary embodiments of the invention, in a case where a pause frame is generated due to congestions or errors in an Ethernet frame transmission system, different pause times are set by service specific priorities so that an Ethernet frame with a low priority can be selectively dropped. This consequently assures performance according to Ethernet frames and maximizes performance and efficiency of the Ethernet network for transmitting the Ethernet frame.

While the present invention has been shown and described in connection with the preferred embodiments, it will be apparent to those skilled in the art that modifications and variations can be made without departing from the spirit and scope of the invention as defined by the appended claims.

What is claimed is:

1. A method for guaranteeing a service specific bandwidth in an Ethernet frame transmission system comprising:
monitoring congestions or errors in the Ethernet frame transmission system;
obtaining memory status information of an input frame buffer and usable bandwidth information of a present Ethernet network if congestions or errors occur in the Ethernet frame transmission system;
setting different pause times by service specific priorities based on the memory status information and the usable bandwidth information;
generating a pause frame having the set pause times; and
transmitting a MAC control frame including the pause frame to the corresponding adjacent nodes.

2. The method according to claim 1, wherein the MAC control frame includes a destination address, a source address, an Ethernet type, a media access control operation code, a media access control parameter and a reserved field, and
wherein the media access control parameter has a value of the pause frame inserted theretinto.

3. The method according to claim 2, wherein the media access control parameter field includes the pause times and priority values.

4. The method according to claim 3, wherein the priority values match, one by one, Ethernet VLAN priority bits.

5. A method for guaranteeing a service specific bandwidth in an Ethernet frame transmission system comprising:
monitoring an Ethernet frame inputted through a corresponding port from each of adjacent nodes;
deciphering a MAC control frame inputted if the Ethernet frame is a MAC control frame;
detecting a pause frame from the deciphered MAC control frame;
detecting pause times set differently by priorities assigned per service class from the detected pause frame;
generating drop information by priorities based on the detected pause times; and
dropping a corresponding Ethernet frame based on the generated drop information.

6. The method according to claim 5, wherein the drop information is generated based on the pause times, state information of an output Ethernet buffer and usable bandwidth information of a present Ethernet network.

7. The method according to claim 5, wherein the MAC control frame includes a destination address, a source address, an Ethernet type, a media access control operation code, a media access control parameter and a reserved field, and
wherein the media access control parameter has a value of the pause frame inserted thereinto.

8. The method according to claim 7, wherein the media access control parameter field includes the pause times and priority values.

9. The method according to claim 8, wherein the priority values match, one by one, Ethernet VLAN priority bits for deciding the service class.

10. An apparatus for guaranteeing a service-specific bandwidth in an Ethernet frame transmission system comprising:
a frame transceiver for transmitting/receiving Ethernet frames through a plurality of ports;
a media access control processor for monitoring the ports, identifying usable bandwidth information of a present Ethernet network depending on congestions or system errors, and deciphering the received Ethernet frames;
an input Ethernet frame buffer for storing the received Ethernet frames temporarily;
a signal processor for setting different pause times by service specific priorities based on memory state information of an input Ethernet frame buffer and the usable bandwidth information, adding a pause frame including the set pause times to a MAC control frame and providing the MAC control frame to adjacent nodes;
a network processor for classifying the Ethernet frames, inputted from the input Ethernet frame buffer, by services, assigning the Ethernet frames with priorities, and outputting the priority-assigned Ethernet frames; and
an output Ethernet frame buffer for storing the output Ethernet frames temporarily.

11. The apparatus according to claim 10, wherein the media access control processor, if the received Ethernet frame is the MAC control frame, detects the pause frame from the MAC control frame, detects the pause times by priorities in the detected pause frame and transmits the detected pause time to the signal processor.

12. The apparatus according to claim 10, wherein the signal processor, if the received Ethernet frame is the MAC control frame, transmits drop information by priorities to the network processor based on the pause times by priorities in the pause frame detected in the MAC control frame.

13. The apparatus according to claim 12, wherein the signal processor sets critical values of the input Ethernet frame buffer and the output Ethernet frame buffer, respectively, and receives memory state information from the input Ethernet frame buffer and the output Ethernet frame buffer.

14. The apparatus according to claim 10, wherein the network processor drops a corresponding one of the Ethernet frames according to the drop information by priorities generated from the signal processor.

15. The apparatus according to claim 14, wherein the drop information is generated based on the pause times, the memory state information of the output Ethernet frame buffer and the usable bandwidth information of the present Ethernet network.

16. The apparatus according to claim 11 or 12, wherein the MAC control frame includes a destination address, a source address, an Ethernet type, a media access control operation code, a media access control parameter and a reserved field, wherein the media access control parameter has a value of the pause frame inserted thereinto.

17. The apparatus according to claim 16, wherein the MAC control parameter field includes the pause times and priority values.

18. The apparatus according to claim 17, wherein the priority values match, one by one, Ethernet VLAN priority bits for deciding the service class.
